(19) United States
(12) Patent Application Publication
(10) Pub. No.: US 2025/0094935 A1
(43) Pub. Date: Mar. 20, 2025

(54) INTEGRATED SERVICE PLATFORM

(71) Applicant: Tyco Fire & Security GmbH, Neuhausen am Rheinfall (CH)

(72) Inventors: Robert A. Jones, Milwaukee, WI (US); Jennifer M. Taranto, Milwaukee, WI (US); Paul T. Hume, Milwaukee, WI (US); Grant S. Bowald, Milwaukee, WI (US); Bobby Pidgeon, Milwaukee, WI (US); Kristopher M. Jackson, Milwaukee, WI (US); Thomas J. Bullen, JR., Milwaukee, WI (US)

(73) Assignee: Tyco Fire & Security GmbH, Neuhausen am Rheinfall (CH)

(21) Appl. No.: 18/890,375

(22) Filed: Sep. 19, 2024

Related U.S. Application Data
(60) Provisional application No. 63/583,998, filed on Sep. 20, 2023.

(51) Int. Cl. G06Q 10/20; G06K 19/06; G06Q 10/087

(52) U.S. Cl. CPC G06Q 10/20; G06K 19/06037; G06Q 10/087

(57) ABSTRACT

A control panel comprising a display configured to display a quick response (QR) code, and a processing circuit having a processor and a memory having computer-executable instructions embodied therein that, when executed by the processor cause the processing circuit to perform operations. The operations comprise receiving, from a plurality of systems associated with a building, building data, and encoding the QR code based on the building data such that the QR code changes responsive to changes in the building data, wherein the changes in the QR cause the QR code to provide different interfaces or applications when scanned by a user device.

### CROSS-REFERENCE TO RELATED PATENT APPLICATION

This application claims the benefit of and priority to U.S. Provisional Patent Application No. 63/583,998, filed Sep. 20, 2023, the entire disclosure of which is hereby incorporated by reference in its entirety.

### BACKGROUND

A building management system (BMS) is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include METASYS® building controllers or other devices sold by Johnson Controls, Inc., as well as building devices and components from other sources.

A BMS may include one or more computer systems (e.g., servers, BMS controllers, etc.) that serve as enterprise level controllers, application or data servers, head nodes, master controllers, or field controllers for the BMS. Such computer systems may communicate with multiple downstream building systems or subsystems (e.g., an HVAC system, a security system, etc.) according to like or disparate protocols (e.g., LON, BACnet, etc.). The computer systems may also provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and devices.

### SUMMARY

One implementation of the present disclosure is a control panel comprising a display configured to display a quick response (QR) code, and a processing circuit having a processor and a memory having computer-executable instructions embodied therein that, when executed by the processor cause the processing circuit to perform operations. The operations comprise receiving, from a plurality of systems associated with a building, building data, and encoding the QR code based on the building data such that the QR code changes responsive to changes in the building data, wherein the changes in the QR cause the QR code to provide different interfaces or applications when scanned by a user device.

Another implementation of the present disclosure is a building device comprising a control panel including a display configured to display a quick response (QR) code, and a processing circuit having a processor and a memory having computer-executable instructions embodied therein that, when executed by the processor cause the processing circuit to perform operations. The operations comprise receiving, from equipment or devices associated with a building, building data, and encoding the QR code based on the building data such that the QR code changes responsive to changes in the building data, wherein in response to the QR code being scanned an interface is provided that includes a service, maintenance, and/or upgrade recommendation relating to the building.

Another implementation of the present disclosure is a non-transitory computer-readable storage media having computer-executable instructions stored thereon that, when executed by one or more processors, cause the one or more processors to perform operations. The operations comprise receiving, from a plurality of systems associated with a building, building data, and encoding a scannable code based on the building data such that the scannable code changes responsive to changes in the building data, wherein the changes in the scannable code cause the scannable code to provide different interfaces or applications when scanned by a user device.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS), according to some embodiments.

FIG. 2 is a block diagram of a BMS that serves the building of FIG. 1, according to some embodiments.

FIG. 3 is a block diagram of a BMS controller which can be used in the BMS of FIG. 2, according to some embodiments.

FIG. 4 is another block diagram of the BMS that serves the building of FIG. 1, according to some embodiments.

FIG. 5 is a block diagram of a services system that serves the building of FIG. 1, according to some embodiments.

FIG. 6 is a block diagram of a control panel of the services system of FIG. 5, according to some embodiments.

FIG. 7 is a block diagram of an interface populated in response to a user interacting with the control panel of FIG. 6, according to some embodiments.

FIG. 8 is a block diagram of another interface populated in response to a user interacting with the control panel of FIG. 6, according to some embodiments.

FIG. 9 is a block diagram of another interface populated in response to a user interacting with the control panel of FIG. 6, according to some embodiments.

FIG. 10 is a block diagram of another interface populated in response to a user interacting with the control panel of FIG. 6, according to some embodiments.

### DETAILED DESCRIPTION

### Building and Building Management System

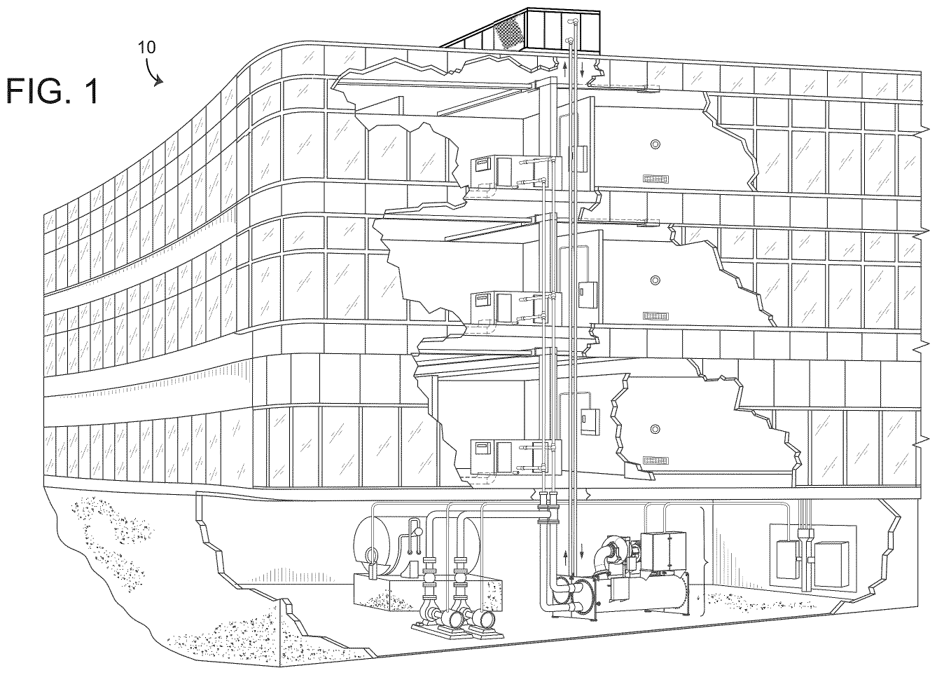

Referring now to FIG. 1, a perspective view of a building 10 is shown, according to an exemplary embodiment. A BMS serves building 10. The BMS for building 10 may include any number or type of devices that serve building 10. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.).

BMS devices may collectively or individually be referred to as building equipment. Building equipment may include any number or type of BMS devices within or around building 10. For example, building equipment may include controllers, chillers, rooftop units, fire and security systems, elevator systems, thermostats, lighting, serviceable equipment (e.g., vending machines), and/or any other type of equipment that can be used to control, automate, or otherwise contribute to an environment, state, or condition of building 10. The terms “BMS devices,” “BMS device” and “building equipment” are used interchangeably throughout this disclosure.

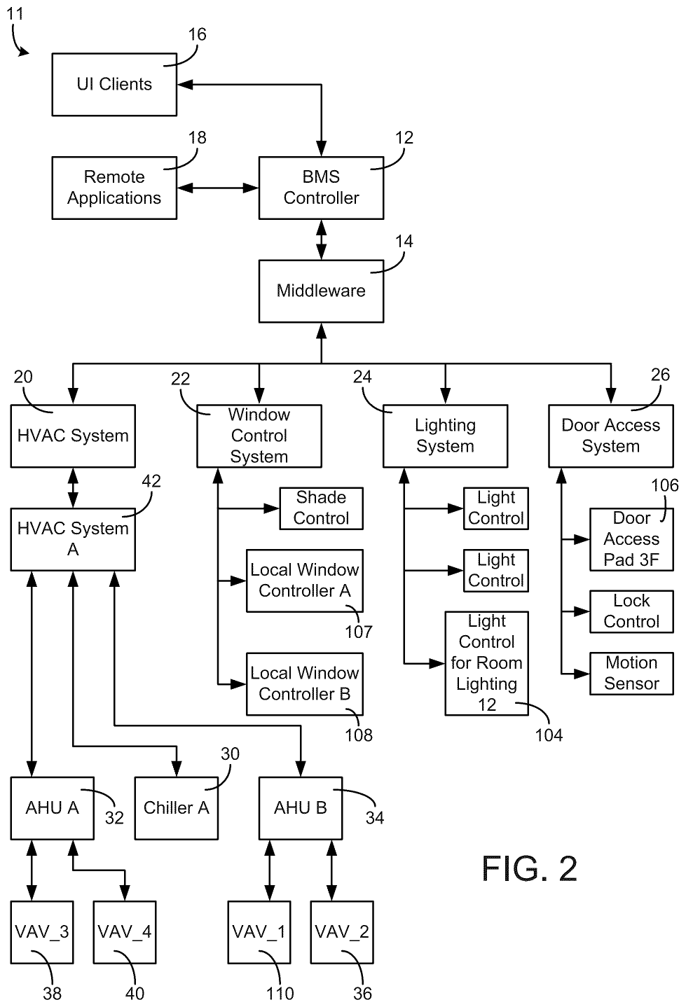

Referring now to FIG. 2, a block diagram of a BMS 11 for building 10 is shown, according to an exemplary embodiment. BMS 11 is shown to include a plurality of BMS subsystems 20-26. Each BMS subsystem 20-26 is connected to a plurality of BMS devices and makes data points for varying connected devices available to upstream BMS controller 12. Additionally, BMS subsystems 20-26 may encompass other lower-level subsystems. For example, an HVAC system may be broken down further as “HVAC system A,” “HVAC system B,” etc. In some buildings, multiple HVAC systems or subsystems may exist in parallel and may not be a part of the same HVAC system 20.

As shown in FIG. 2, BMS 11 may include a HVAC system 20. HVAC system 20 may control HVAC operations building 10. HVAC system 20 is shown to include a lower-level HVAC system 42 (named “HVAC system A”). HVAC system 42 may control HVAC operations for a specific floor or zone of building 10. HVAC system 42 may be connected to air handling units (AHUs) 32, 34 (named “AHU A” and “AHU B,” respectively, in BMS 11). AHU 32 may serve variable air volume (VAV) boxes 38, 40 (named “VAV_3” and “VAV_4” in BMS 11). Likewise, AHU 34 may serve VAV boxes 36 and 110 (named “VAV_2” and “VAV_1”). HVAC system 42 may also include chiller 30 (named “Chiller A” in BMS 11). Chiller 30 may provide chilled fluid to AHU 32 and/or to AHU 34. HVAC system 42 may receive data (i.e., BMS inputs such as temperature sensor readings, damper positions, temperature setpoints, etc.) from AHUs 32, 34. HVAC system 42 may provide such BMS inputs to HVAC system 20 and on to middleware 14 and BMS controller 12. Similarly, other BMS subsystems may receive inputs from other building devices or objects and provide the received inputs to BMS controller 12 (e.g., via middleware 14).

Middleware 14 may include services that allow interoperable communication to, from, or between disparate BMS subsystems 20-26 of BMS 11 (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BMS controller 12, middleware 14 and BMS controller 12 may integrated in some embodiments. For example, middleware 14 may be a part of BMS controller 12.

Still referring to FIG. 2, window control system 22 may receive shade control information from one or more shade controls, ambient light level information from one or more light sensors, and/or other BMS inputs (e.g., sensor information, setpoint information, current state information, etc.) from downstream devices. Window control system 22 may include window controllers 107, 108 (e.g., named “local window controller A” and “local window controller B,” respectively, in BMS 11). Window controllers 107, 108 control the operation of subsets of window control system 22. For example, window controller 108 may control window blind or shade operations for a given room, floor, or building in the BMS.

Lighting system 24 may receive lighting related information from a plurality of downstream light controls (e.g., from room lighting 104). Door access system 26 may receive lock control, motion, state, or other door related information from a plurality of downstream door controls. Door access system 26 is shown to include door access pad 106 (named “Door Access Pad 3F”), which may grant or deny access to a building space (e.g., a floor, a conference room, an office, etc.) based on whether valid user credentials are scanned or entered (e.g., via a keypad, via a badge-scanning pad, etc.).

BMS subsystems 20-26 may be connected to BMS controller 12 via middleware 14 and may be configured to provide BMS controller 12 with BMS inputs from various BMS subsystems 20-26 and their varying downstream devices. BMS controller 12 may be configured to make differences in building subsystems transparent at the human-machine interface or client interface level (e.g., for connected or hosted user interface (UI) clients 16, remote applications 18, etc.). BMS controller 12 may be configured to describe or model different building devices and building subsystems using common or unified objects (e.g., software objects stored in memory) to help provide the transparency. Software equipment objects may allow developers to write applications capable of monitoring and/or controlling various types of building equipment regardless of equipment-specific variations (e.g., equipment model, equipment manufacturer, equipment version, etc.). Software building objects may allow developers to write applications capable of monitoring and/or controlling building zones on a zone-by-zone level regardless of the building subsystem makeup.

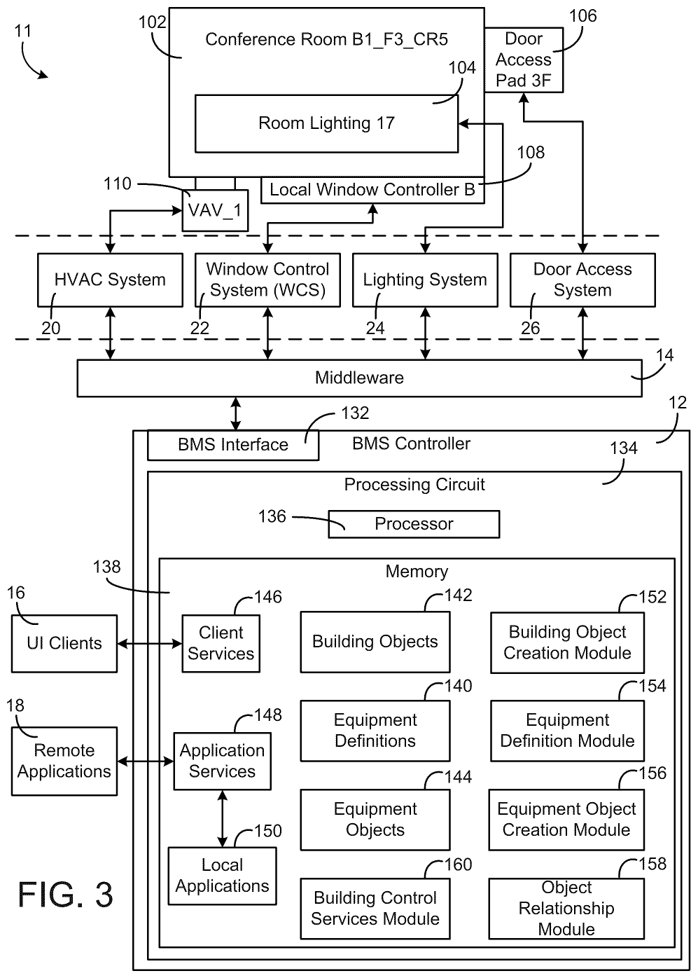

Referring now to FIG. 3, a block diagram illustrating a portion of BMS 11 in greater detail is shown, according to an exemplary embodiment. Particularly, FIG. 3 illustrates a portion of BMS 11 that services a conference room 102 of building 10 (named “B1_F3_CR5”). Conference room 102 may be affected by many different building devices connected to many different BMS subsystems. For example, conference room 102 includes or is otherwise affected by VAV box 110, window controller 108 (e.g., a blind controller), a system of lights 104 (named “Room Lighting 17”), and a door access pad 106.

Each of the building devices shown at the top of FIG. 3 may include local control circuitry configured to provide signals to their supervisory controllers or more generally to the BMS subsystems 20-26. The local control circuitry of the building devices shown at the top of FIG. 3 may also be configured to receive and respond to control signals, commands, setpoints, or other data from their supervisory controllers. For example, the local control circuitry of VAV box 110 may include circuitry that affects an actuator in response to control signals received from a field controller that is a part of HVAC system 20. Window controller 108 may include circuitry that affects windows or blinds in response to control signals received from a field controller that is part of window control system (WCS) 22. Room lighting 104 may include circuitry that affects the lighting in response to control signals received from a field controller that is part of lighting system 24. Access pad 106 may include circuitry that affects door access (e.g., locking or unlocking the door) in response to control signals received from a field controller that is part of door access system 26.

Still referring to FIG. 3, BMS controller 12 is shown to include a BMS interface 132 in communication with middleware 14. In some embodiments, BMS interface 132 is a communications interface. For example, BMS interface 132 may include wired or wireless interfaces (e.g., jacks, antennas, transmitters, receivers, transceivers, wire terminals, etc.) for conducting data communications with various systems, devices, or networks. BMS interface 132 can include an Ethernet card and port for sending and receiving data via an Ethernet-based communications network. In another example, BMS interface 132 includes a Wi-Fi transceiver for communicating via a wireless communications network. BMS interface 132 may be configured to communicate via local area networks or wide area networks (e.g., the Internet, a building WAN, etc.).

In some embodiments, BMS interface 132 and/or middleware 14 includes an application gateway configured to receive input from applications running on client devices. For example, BMS interface 132 and/or middleware 14 may include one or more wireless transceivers (e.g., a Wi-Fi transceiver, a Bluetooth transceiver, a NFC transceiver, a cellular transceiver, etc.) for communicating with client devices. BMS interface 132 may be configured to receive building management inputs from middleware 14 or directly from one or more BMS subsystems 20-26. BMS interface 132 and/or middleware 14 can include any number of software buffers, queues, listeners, filters, translators, or other communications-supporting services.

Still referring to FIG. 3, BMS controller 12 is shown to include a processing circuit 134 including a processor 136 and memory 138. Processor 136 may be a general purpose or specific purpose processor, an application specific integrated circuit (ASIC), one or more field programmable gate arrays (FPGAs), a group of processing components, or other suitable processing components. Processor 136 is configured to execute computer code or instructions stored in memory 138 or received from other computer readable media (e.g., CDROM, network storage, a remote server, etc.).

Memory 138 may include one or more devices (e.g., memory units, memory devices, storage devices, etc.) for storing data and/or computer code for completing and/or facilitating the various processes described in the present disclosure. Memory 138 may include random access memory (RAM), read-only memory (ROM), hard drive storage, temporary storage, non-volatile memory, flash memory, optical memory, or any other suitable memory for storing software objects and/or computer instructions. Memory 138 may include database components, object code components, script components, or any other type of information structure for supporting the various activities and information structures described in the present disclosure. Memory 138 may be communicably connected to processor 136 via processing circuit 134 and may include computer code for executing (e.g., by processor 136) one or more processes described herein. When processor 136 executes instructions stored in memory 138 for completing the various activities described herein, processor 136 generally configures BMS controller 12 (and more particularly processing circuit 134) to complete such activities.

Still referring to FIG. 3, memory 138 is shown to include building objects 142. In some embodiments, BMS controller 12 uses building objects 142 to group otherwise ungrouped or unassociated devices so that the group may be addressed or handled by applications together and in a consistent manner (e.g., a single user interface for controlling all of the BMS devices that affect a particular building zone or room). Building objects can apply to spaces of any granularity. For example, a building object can represent an entire building, a floor of a building, or individual rooms on each floor. In some embodiments, BMS controller 12 creates and/or stores a building object in memory 138 for each zone or room of building 10. Building objects 142 can be accessed by UI clients 16 and remote applications 18 to provide a comprehensive user interface for controlling and/or viewing information for a particular building zone. Building objects 142 may be created by building object creation module 152 and associated with equipment objects by object relationship module 158, described in greater detail below.

Still referring to FIG. 3, memory 138 is shown to include equipment definitions 140. Equipment definitions 140 stores the equipment definitions for various types of building equipment. Each equipment definition may apply to building equipment of a different type. For example, equipment definitions 140 may include different equipment definitions for variable air volume modular assemblies (VMAs), fan coil units, air handling units (AHUs), lighting fixtures, water pumps, and/or other types of building equipment.

Equipment definitions 140 define the types of data points that are generally associated with various types of building equipment. For example, an equipment definition for VMA may specify data point types such as room temperature, damper position, supply air flow, and/or other types of data measured or used by the VMA. Equipment definitions 140 allow for the abstraction (e.g., generalization, normalization, broadening, etc.) of equipment data from a specific BMS device so that the equipment data can be applied to a room or space.

Each of equipment definitions 140 may include one or more point definitions. Each point definition may define a data point of a particular type and may include search criteria for automatically discovering and/or identifying data points that satisfy the point definition. An equipment definition can be applied to multiple pieces of building equipment of the same general type (e.g., multiple different VMA controllers). When an equipment definition is applied to a BMS device, the search criteria specified by the point definitions can be used to automatically identify data points provided by the BMS device that satisfy each point definition.

In some embodiments, equipment definitions 140 define data point types as generalized types of data without regard to the model, manufacturer, vendor, or other differences between building equipment of the same general type. The generalized data points defined by equipment definitions 140 allows each equipment definition to be referenced by or applied to multiple different variants of the same type of building equipment.

In some embodiments, equipment definitions 140 facilitate the presentation of data points in a consistent and user-friendly manner. For example, each equipment definition may define one or more data points that are displayed via a user interface. The displayed data points may be a subset of the data points defined by the equipment definition.

In some embodiments, equipment definitions 140 specify a system type (e.g., HVAC, lighting, security, fire, etc.), a system sub-type (e.g., terminal units, air handlers, central plants), and/or data category (e.g., critical, diagnostic, operational) associated with the building equipment defined by each equipment definition. Specifying such attributes of building equipment at the equipment definition level allows the attributes to be applied to the building equipment along with the equipment definition when the building equipment is initially defined. Building equipment can be filtered by various attributes provided in the equipment definition to facilitate the reporting and management of equipment data from multiple building systems.

Equipment definitions 140 can be automatically created by abstracting the data points provided by archetypal controllers (e.g., typical or representative controllers) for various types of building equipment. In some embodiments, equipment definitions 140 are created by equipment definition module 154, described in greater detail below.

Still referring to FIG. 3, memory 138 is shown to include equipment objects 144. Equipment objects 144 may be software objects that define a mapping between a data point type (e.g., supply air temperature, room temperature, damper position) and an actual data point (e.g., a measured or calculated value for the corresponding data point type) for various pieces of building equipment. Equipment objects 144 may facilitate the presentation of equipment-specific data points in an intuitive and user-friendly manner by associating each data point with an attribute identifying the corresponding data point type. The mapping provided by equipment objects 144 may be used to associate a particular data value measured or calculated by BMS 11 with an attribute that can be displayed via a user interface.

Equipment objects 144 can be created (e.g., by equipment object creation module 156) by referencing equipment definitions 140. For example, an equipment object can be created by applying an equipment definition to the data points provided by a BMS device. The search criteria included in an equipment definition can be used to identify data points of the building equipment that satisfy the point definitions. A data point that satisfies a point definition can be mapped to an attribute of the equipment object corresponding to the point definition.

Each equipment object may include one or more attributes defined by the point definitions of the equipment definition used to create the equipment object. For example, an equipment definition which defines the attributes “Occupied Command,” “Room Temperature,” and “Damper Position” may result in an equipment object being created with the same attributes. The search criteria provided by the equipment definition are used to identify and map data points associated with a particular BMS device to the attributes of the equipment object. The creation of equipment objects is described in greater detail below with reference to equipment object creation module 156.

Equipment objects 144 may be related with each other and/or with building objects 142. Causal relationships can be established between equipment objects to link equipment objects to each other. For example, a causal relationship can be established between a VMA and an AHU which provides airflow to the VMA. Causal relationships can also be established between equipment objects 144 and building objects 142. For example, equipment objects 144 can be associated with building objects 142 representing particular rooms or zones to indicate that the equipment object serves that room or zone. Relationships between objects are described in greater detail below with reference to object relationship module 158.

Still referring to FIG. 3, memory 138 is shown to include client services 146 and application services 148. Client services 146 may be configured to facilitate interaction and/or communication between BMS controller 12 and various internal or external clients or applications. For example, client services 146 may include web services or application programming interfaces available for communication by UI clients 16 and remote applications 18 (e.g., applications running on a mobile device, energy monitoring applications, applications allowing a user to monitor the performance of the BMS, automated fault detection and diagnostics systems, etc.). Application services 148 may facilitate direct or indirect communications between remote applications 18, local applications 150, and BMS controller 12. For example, application services 148 may allow BMS controller 12 to communicate (e.g., over a communications network) with remote applications 18 running on mobile devices and/or with other BMS controllers.

In some embodiments, application services 148 facilitate an applications gateway for conducting electronic data communications with UI clients 16 and/or remote applications 18. For example, application services 148 may be configured to receive communications from mobile devices and/or BMS devices. Client services 146 may provide client devices with a graphical user interface that consumes data points and/or display data defined by equipment definitions 140 and mapped by equipment objects 144.

Still referring to FIG. 3, memory 138 is shown to include a building object creation module 152. Building object creation module 152 may be configured to create the building objects stored in building objects 142. Building object creation module 152 may create a software building object for various spaces within building 10. Building object creation module 152 can create a building object for a space of any size or granularity. For example, building object creation module 152 can create a building object representing an entire building, a floor of a building, or individual rooms on each floor. In some embodiments, building object creation module 152 creates and/or stores a building object in memory 138 for each zone or room of building 10.

The building objects created by building object creation module 152 can be accessed by UI clients 16 and remote applications 18 to provide a comprehensive user interface for controlling and/or viewing information for a particular building zone. Building objects 142 can group otherwise ungrouped or unassociated devices so that the group may be addressed or handled by applications together and in a consistent manner (e.g., a single user interface for controlling all of the BMS devices that affect a particular building zone or room). In some embodiments, building object creation module 152 uses the systems and methods described in U.S. patent application Ser. No. 12/887,390, filed Sep. 21, 2010, for creating software defined building objects.

In some embodiments, building object creation module 152 provides a user interface for guiding a user through a process of creating building objects. For example, building object creation module 152 may provide a user interface to client devices (e.g., via client services 146) that allows a new space to be defined. In some embodiments, building object creation module 152 defines spaces hierarchically. For example, the user interface for creating building objects may prompt a user to create a space for a building, for floors within the building, and/or for rooms or zones within each floor.

In some embodiments, building object creation module 152 creates building objects automatically or semi-automatically. For example, building object creation module 152 may automatically define and create building objects using data imported from another data source (e.g., user view folders, a table, a spreadsheet, etc.). In some embodiments, building object creation module 152 references an existing hierarchy for BMS 11 to define the spaces within building 10. For example, BMS 11 may provide a listing of controllers for building 10 (e.g., as part of a network of data points) that have the physical location (e.g., room name) of the controller in the name of the controller itself. Building object creation module 152 may extract room names from the names of BMS controllers defined in the network of data points and create building objects for each extracted room. Building objects may be stored in building objects 142.

Still referring to FIG. 3, memory 138 is shown to include an equipment definition module 154. Equipment definition module 154 may be configured to create equipment definitions for various types of building equipment and to store the equipment definitions in equipment definitions 140. In some embodiments, equipment definition module 154 creates equipment definitions by abstracting the data points provided by archetypal controllers (e.g., typical or representative controllers) for various types of building equipment. For example, equipment definition module 154 may receive a user selection of an archetypal controller via a user interface. The archetypal controller may be specified as a user input or selected automatically by equipment definition module 154. In some embodiments, equipment definition module 154 selects an archetypal controller for building equipment associated with a terminal unit such as a VMA.

Equipment definition module 154 may identify one or more data points associated with the archetypal controller. Identifying one or more data points associated with the archetypal controller may include accessing a network of data points provided by BMS 11. The network of data points may be a hierarchical representation of data points that are measured, calculated, or otherwise obtained by various BMS devices. BMS devices may be represented in the network of data points as nodes of the hierarchical representation with associated data points depending from each BMS device. Equipment definition module 154 may find the node corresponding to the archetypal controller in the network of data points and identify one or more data points which depend from the archetypal controller node.

Equipment definition module 154 may generate a point definition for each identified data point of the archetypal controller. Each point definition may include an abstraction of the corresponding data point that is applicable to multiple different controllers for the same type of building equipment. For example, an archetypal controller for a particular VMA (i.e., “VMA-20”) may be associated an equipment-specific data point such as “VMA-20.DPR-POS” (i.e., the damper position of VMA-20) and/or “VMA-20.SUP-FLOW” (i.e., the supply air flow rate through VMA-20). Equipment definition module 154 abstract the equipment-specific data points to generate abstracted data point types that are generally applicable to other equipment of the same type. For example, equipment definition module 154 may abstract the equipment-specific data point “VMA-20.DPR-POS” to generate the abstracted data point type “DPR-POS” and may abstract the equipment-specific data point “VMA-20.SUP-FLOW” to generate the abstracted data point type “SUP-FLOW.” Advantageously, the abstracted data point types generated by equipment definition module 154 can be applied to multiple different variants of the same type of building equipment (e.g., VMAs from different manufacturers, VMAs having different models or output data formats, etc.).

In some embodiments, equipment definition module 154 generates a user-friendly label for each point definition. The user-friendly label may be a plain text description of the variable defined by the point definition. For example, equipment definition module 154 may generate the label “Supply Air Flow” for the point definition corresponding to the abstracted data point type “SUP-FLOW” to indicate that the data point represents a supply air flow rate through the VMA. The labels generated by equipment definition module 154 may be displayed in conjunction with data values from BMS devices as part of a user-friendly interface.

In some embodiments, equipment definition module 154 generates search criteria for each point definition. The search criteria may include one or more parameters for identifying another data point (e.g., a data point associated with another controller of BMS 11 for the same type of building equipment) that represents the same variable as the point definition. Search criteria may include, for example, an instance number of the data point, a network address of the data point, and/or a network point type of the data point.

In some embodiments, search criteria include a text string abstracted from a data point associated with the archetypal controller. For example, equipment definition module 154 may generate the abstracted text string “SUP-FLOW” from the equipment-specific data point “VMA-20.SUP-FLOW.” Advantageously, the abstracted text string matches other equipment-specific data points corresponding to the supply air flow rates of other BMS devices (e.g., “VMA-18.SUP-FLOW,” “SUP-FLOW.VMA-01,” etc.). Equipment definition module 154 may store a name, label, and/or search criteria for each point definition in memory 138.

Equipment definition module 154 may use the generated point definitions to create an equipment definition for a particular type of building equipment (e.g., the same type of building equipment associated with the archetypal controller). The equipment definition may include one or more of the generated point definitions. Each point definition defines a potential attribute of BMS devices of the particular type and provides search criteria for identifying the attribute among other data points provided by such BMS devices.

In some embodiments, the equipment definition created by equipment definition module 154 includes an indication of display data for BMS devices that reference the equipment definition. Display data may define one or more data points of the BMS device that will be displayed via a user interface. In some embodiments, display data are user defined. For example, equipment definition module 154 may prompt a user to select one or more of the point definitions included in the equipment definition to be represented in the display data. Display data may include the user-friendly label (e.g., “Damper Position”) and/or short name (e.g., “DPR-POS”) associated with the selected point definitions.

In some embodiments, equipment definition module 154 provides a visualization of the equipment definition via a graphical user interface. The visualization of the equipment definition may include a point definition portion which displays the generated point definitions, a user input portion configured to receive a user selection of one or more of the point definitions displayed in the point definition portion, and/or a display data portion which includes an indication of an abstracted data point corresponding to each of the point definitions selected via the user input portion. The visualization of the equipment definition can be used to add, remove, or change point definitions and/or display data associated with the equipment definitions.

Equipment definition module 154 may generate an equipment definition for each different type of building equipment in BMS 11 (e.g., VMAs, chillers, AHUs, etc.). Equipment definition module 154 may store the equipment definitions in a data storage device (e.g., memory 138, equipment definitions 140, an external or remote data storage device, etc.).

Still referring to FIG. 3, memory 138 is shown to include an equipment object creation module 156. Equipment object creation module 156 may be configured to create equipment objects for various BMS devices. In some embodiments, equipment object creation module 156 creates an equipment object by applying an equipment definition to the data points provided by a BMS device. For example, equipment object creation module 156 may receive an equipment definition created by equipment definition module 154. Receiving an equipment definition may include loading or retrieving the equipment definition from a data storage device.

In some embodiments, equipment object creation module 156 determines which of a plurality of equipment definitions to retrieve based on the type of BMS device used to create the equipment object. For example, if the BMS device is a VMA, equipment object creation module 156 may retrieve the equipment definition for VMAs; whereas if the BMS device is a chiller, equipment object creation module 156 may retrieve the equipment definition for chillers. The type of BMS device to which an equipment definition applies may be stored as an attribute of the equipment definition. Equipment object creation module 156 may identify the type of BMS device being used to create the equipment object and retrieve the corresponding equipment definition from the data storage device.

In other embodiments, equipment object creation module 156 receives an equipment definition prior to selecting a BMS device. Equipment object creation module 156 may identify a BMS device of BMS 11 to which the equipment definition applies. For example, equipment object creation module 156 may identify a BMS device that is of the same type of building equipment as the archetypal BMS device used to generate the equipment definition. In various embodiments, the BMS device used to generate the equipment object may be selected automatically (e.g., by equipment object creation module 156), manually (e.g., by a user) or semi-automatically (e.g., by a user in response to an automated prompt from equipment object creation module 156).

In some embodiments, equipment object creation module 156 creates an equipment discovery table based on the equipment definition. For example, equipment object creation module 156 may create an equipment discovery table having attributes (e.g., columns) corresponding to the variables defined by the equipment definition (e.g., a damper position attribute, a supply air flow rate attribute, etc.). Each column of the equipment discovery table may correspond to a point definition of the equipment definition. The equipment discovery table may have columns that are categorically defined (e.g., representing defined variables) but not yet mapped to any particular data points.

Equipment object creation module 156 may use the equipment definition to automatically identify one or more data points of the selected BMS device to map to the columns of the equipment discovery table. Equipment object creation module 156 may search for data points of the BMS device that satisfy one or more of the point definitions included in the equipment definition. In some embodiments, equipment object creation module 156 extracts a search criterion from each point definition of the equipment definition. Equipment object creation module 156 may access a data point network of the building automation system to identify one or more data points associated with the selected BMS device. Equipment object creation module 156 may use the extracted search criterion to determine which of the identified data points satisfy one or more of the point definitions.

In some embodiments, equipment object creation module 156 automatically maps (e.g., links, associates, relates, etc.) the identified data points of selected BMS device to the equipment discovery table. A data point of the selected BMS device may be mapped to a column of the equipment discovery table in response to a determination by equipment object creation module 156 that the data point satisfies the point definition (e.g., the search criteria) used to generate the column. For example, if a data point of the selected BMS device has the name “VMA-18.SUP-FLOW” and a search criterion is the text string “SUP-FLOW,” equipment object creation module 156 may determine that the search criterion is met. Accordingly, equipment object creation module 156 may map the data point of the selected BMS device to the corresponding column of the equipment discovery table.

Advantageously, equipment object creation module 156 may create multiple equipment objects and map data points to attributes of the created equipment objects in an automated fashion (e.g., without human intervention, with minimal human intervention, etc.). The search criteria provided by the equipment definition facilitates the automatic discovery and identification of data points for a plurality of equipment object attributes. Equipment object creation module 156 may label each attribute of the created equipment objects with a device-independent label derived from the equipment definition used to create the equipment object. The equipment objects created by equipment object creation module 156 can be viewed (e.g., via a user interface) and/or interpreted by data consumers in a consistent and intuitive manner regardless of device-specific differences between BMS devices of the same general type. The equipment objects created by equipment object creation module 156 may be stored in equipment objects 144.

Still referring to FIG. 3, memory 138 is shown to include an object relationship module 158. Object relationship module 158 may be configured to establish relationships between equipment objects 144. In some embodiments, object relationship module 158 establishes causal relationships between equipment objects 144 based on the ability of one BMS device to affect another BMS device. For example, object relationship module 158 may establish a causal relationship between a terminal unit (e.g., a VMA) and an upstream unit (e.g., an AHU, a chiller, etc.) which affects an input provided to the terminal unit (e.g., air flow rate, air temperature, etc.).

Object relationship module 158 may establish relationships between equipment objects 144 and building objects 142 (e.g., spaces). For example, object relationship module 158 may associate equipment objects 144 with building objects 142 representing particular rooms or zones to indicate that the equipment object serves that room or zone. In some embodiments, object relationship module 158 provides a user interface through which a user can define relationships between equipment objects 144 and building objects 142. For example, a user can assign relationships in a “drag and drop” fashion by dragging and dropping a building object and/or an equipment object into a “serving” cell of an equipment object provided via the user interface to indicate that the BMS device represented by the equipment object serves a particular space or BMS device.

Still referring to FIG. 3, memory 138 is shown to include a building control services module 160. Building control services module 160 may be configured to automatically control BMS 11 and the various subsystems thereof. Building control services module 160 may utilize closed loop control, feedback control, PI control, model predictive control, or any other type of automated building control methodology to control the environment (e.g., a variable state or condition) within building 10.

Building control services module 160 may receive inputs from sensory devices (e.g., temperature sensors, pressure sensors, flow rate sensors, humidity sensors, electric current sensors, cameras, radio frequency sensors, microphones, etc.), user input devices (e.g., computer terminals, client devices, user devices, etc.) or other data input devices via BMS interface 132. Building control services module 160 may apply the various inputs to a building energy use model and/or a control algorithm to determine an output for one or more building control devices (e.g., dampers, air handling units, chillers, boilers, fans, pumps, etc.) in order to affect a variable state or condition within building 10 (e.g., zone temperature, humidity, air flow rate, etc.).

In some embodiments, building control services module 160 is configured to control the environment of building 10 on a zone-individualized level. For example, building control services module 160 may control the environment of two or more different building zones using different setpoints, different constraints, different control methodology, and/or different control parameters. Building control services module 160 may operate BMS 11 to maintain building conditions (e.g., temperature, humidity, air quality, etc.) within a setpoint range, to optimize energy performance (e.g., to minimize energy consumption, to minimize energy cost, etc.), and/or to satisfy any constraint or combination of constraints as may be desirable for various implementations.

In some embodiments, building control services module 160 uses the location of various BMS devices to translate an input received from a building system into an output or control signal for the building system. Building control services module 160 may receive location information for BMS devices and automatically set or recommend control parameters for the BMS devices based on the locations of the BMS devices. For example, building control services module 160 may automatically set a flow rate setpoint for a VAV box based on the size of the building zone in which the VAV box is located.

Building control services module 160 may determine which of a plurality of sensors to use in conjunction with a feedback control loop based on the locations of the sensors within building 10. For example, building control services module 160 may use a signal from a temperature sensor located in a building zone as a feedback signal for controlling the temperature of the building zone in which the temperature sensor is located.

In some embodiments, building control services module 160 automatically generates control algorithms for a controller or a building zone based on the location of the zone in the building 10. For example, building control services module 160 may be configured to predict a change in demand resulting from sunlight entering through windows based on the orientation of the building and the locations of the building zones (e.g., cast-facing, west-facing, perimeter zones, interior zones, etc.).

Building control services module 160 may use zone location information and interactions between adjacent building zones (rather than considering each zone as an isolated system) to more efficiently control the temperature and/or airflow within building 10. For control loops that are conducted at a larger scale (i.e., floor level) building control services module 160 may use the location of each building zone and/or BMS device to coordinate control functionality between building zones. For example, building control services module 160 may consider heat exchange and/or air exchange between adjacent building zones as a factor in determining an output control signal for the building zones.

In some embodiments, building control services module 160 is configured to optimize the energy efficiency of building 10 using the locations of various BMS devices and the control parameters associated therewith. Building control services module 160 may be configured to achieve control setpoints using building equipment with a relatively lower energy cost (e.g., by causing airflow between connected building zones) in order to reduce the loading on building equipment with a relatively higher energy cost (e.g., chillers and roof top units). For example, building control services module 160 may be configured to move warmer air from higher elevation zones to lower elevation zones by establishing pressure gradients between connected building zones.

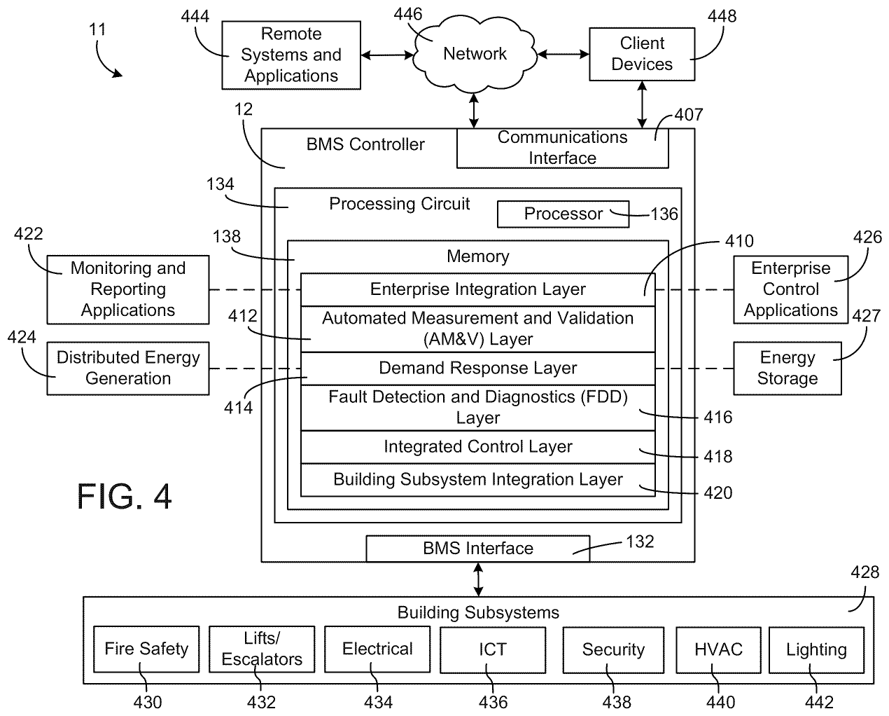

Referring now to FIG. 4, another block diagram illustrating a portion of BMS 11 in greater detail is shown, according to some embodiments. BMS 11 can be implemented in building 10 to automatically monitor and control various building functions. BMS 11 is shown to include BMS controller 12 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10.

Each of building subsystems 428 can include any number of devices, controllers, and connections for completing its individual functions and control activities. HVAC subsystem 440 can include many of the same components as HVAC system 20, as described with reference to FIGS. 2-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 12 is shown to include a communications interface 407 and a BMS interface 132. Interface 407 may facilitate communications between BMS controller 12 and external applications (e.g., monitoring and reporting applications 422, enterprise control applications 426, remote systems and applications 444, applications residing on client devices 448, etc.) for allowing user control, monitoring, and adjustment to BMS controller 12 and/or subsystems 428. Interface 407 may also facilitate communications between BMS controller 12 and client devices 448. BMS interface 132 may facilitate communications between BMS controller 12 and building subsystems 428 (e.g., HVAC, lighting security, lifts, power distribution, business, etc.).

Interfaces 407, 132 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 132 can be direct (e.g., local wired or wireless communications) or via a communications network 446 (e.g., a WAN, the Internet, a cellular network, etc.). For example, interfaces 407, 132 can include an Ethernet card and port for sending and receiving data via an Ethernet-based communications link or network. In another example, interfaces 407, 132 can include a Wi-Fi transceiver for communicating via a wireless communications network. In another example, one or both of interfaces 407, 132 can include cellular or mobile phone communications transceivers. In one embodiment, communications interface 407 is a power line communications interface and BMS interface 132 is an Ethernet interface. In other embodiments, both communications interface 407 and BMS interface 132 are Ethernet interfaces or are the same Ethernet interface.

Still referring to FIG. 4, BMS controller 12 is shown to include a processing circuit 134 including a processor 136 and memory 138. Processing circuit 134 can be communicably connected to BMS interface 132 and/or communications interface 407 such that processing circuit 134 and the various components thereof can send and receive data via interfaces 407, 132. Processor 136 can be implemented as a general purpose processor, an application specific integrated circuit (ASIC), one or more field programmable gate arrays (FPGAs), a group of processing components, or other suitable electronic processing components.

Memory 138 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 138 can be or include volatile memory or non-volatile memory. Memory 138 can include database components, object code components, script components, or any other type of information structure for supporting the various activities and information structures described in the present application. According to some embodiments, memory 138 is communicably connected to processor 136 via processing circuit 134 and includes computer code for executing (e.g., by processing circuit 134 and/or processor 136) one or more processes described herein.

In some embodiments, BMS controller 12 is implemented within a single computer (e.g., one server, one housing, etc.). In various other embodiments BMS controller 12 can be distributed across multiple servers or computers (e.g., that can exist in distributed locations). Further, while FIG. 4 shows applications 422 and 426 as existing outside of BMS controller 12, in some embodiments, applications 422 and 426 can be hosted within BMS controller 12 (e.g., within memory 138).

Still referring to FIG. 4, memory 138 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 11.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 12. In yet other embodiments, enterprise control applications 426 can work with layers 410-420 to optimize building performance (e.g., efficiency, energy use, comfort, or safety) based on inputs received at interface 407 and/or BMS interface 132.

Building subsystem integration layer 420 can be configured to manage communications between BMS controller 12 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427, or from other sources. Demand response layer 414 may receive inputs from other layers of BMS controller 12 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 11 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Integrated Services System

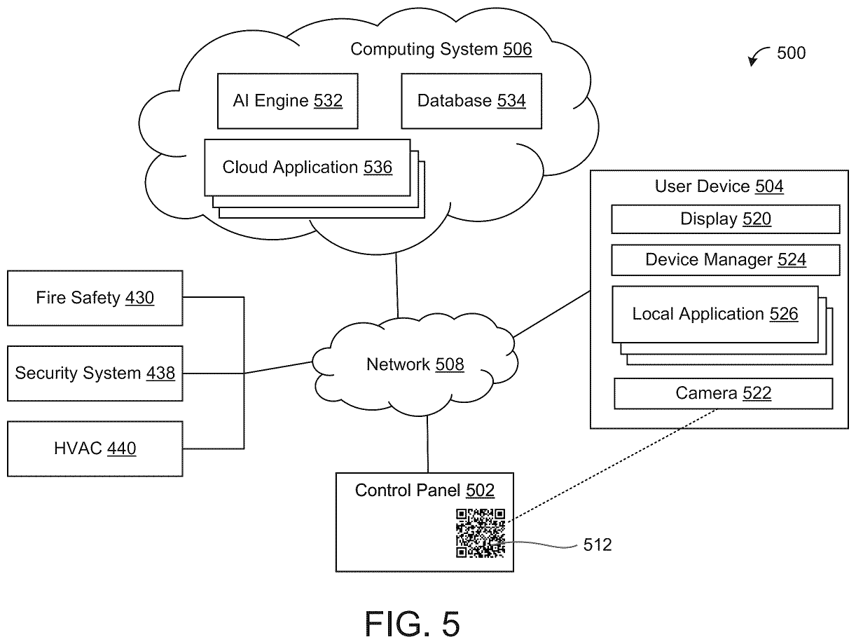

Referring now to FIG. 5, a block diagram of an integrated services system or services system 500 is shown, according to an exemplary embodiment. The services system 500 may be implemented with one or more components of a building management system. For example, the services system 500 may be implemented with the BMS 11, a component of the BMS subsystems 20-26, and/or a BMS device, as described herein. According to an exemplary embodiment, the services system 500 is configured to execute one or more system control functions relating to a building (e.g., the building 10). For example, the services system 500 may be configured to initiate one or more automated actions or control decisions relating to one or more components of a building (e.g., a component or device of a building, etc.), as described herein. Further, the services system 500 may be configured to generate and/or display information relating to one or more components of a building (e.g., the building 10, etc.), for example information relating to a component or device of the building, as also described herein.

The services system 500 is shown to include a control panel 502, a user device 504, and a computing system or computing platform, shown as computing system 506. The services system 500 may also include one or more components of a building, a building system, and/or a building subsystem, as described herein. For example, the services system 500 is shown to include a fire system or subsystem, shown as the fire safety subsystem 430, a security system or security subsystem, shown as the security subsystem 438, and a HVAC system or subsystem, shown as the HVAC subsystem 440. It should be understood that while the services system 500 of FIG. 5 is shown to include certain systems and/or subsystems, it is contemplated that in other embodiments the services system 500 includes additional, fewer, and/or additional systems and/or subsystems, as described herein. The components of the services system 500 may be connected, or in communication, via a network 508.

As will be discussed in greater detail below, the control panel 502 may be configured to receive information and/or data from one or more components of the services system 500 (e.g., the user device 504, the computing system 506, the fire safety system 430, the security subsystem 438, the HVAC subsystem 440, etc.), process and/or encode a quick response (QR) code using the information and/or data, and/or display the QR code, for example to be scanned by a device. The QR code may cause the device (e.g., the user device 504, a computing device, the computing system 506, etc.) to provide (e.g., activate, initiate, populate, launch, etc.) one or more applications or interfaces, for example to provide information and/or one or more recommended actions to a user or operator. As will be described herein, the one or more applications and/or interfaces may be configured to provide (e.g., display, present, etc.) information relating to the control panel 502 and/or one or more connected systems or devices (e.g., a component or device of the building 10, the fire safety system 430, the security subsystem 438, the HVAC subsystem 440, etc.).

As shown, the control panel 502 includes a machine readable code, shown as a quick response code or a QR code 512. As described herein, the QR code 512 may be configured to contain information, for example encoded information relating to the control panel 502 and/or one or more connected systems or devices. In an exemplary embodiment, the QR code 512 is scannable (e.g., via a camera, a user device, a mobile device, etc.), and is configured to populate one or more applications and/or interfaces that provide (e.g., display, etc.) information relating to the control panel 502 and/or connected systems or devices (e.g., a component of device of the BMS subsystems 20-26, etc.).

In some embodiments, the QR code 512 is provided (e.g., encoded, encrypted, etc.), such that the QR code 512 provides (e.g., allows, affords, etc.) sets or subsets of system functionalities. For example, in response to a first entity scanning the QR code 512 (e.g., a user device associated with a technician or operator of the building 10, etc.) a first level of access and/or permission may be granted (e.g., access to a predetermined set of data or device information, permission or ability to modify certain operating parameters, setpoints, and/or conditions, etc.). Conversely, in response to a second entity scanning the QR code 512 (e.g., a user device associated with a visitor of the building 10, etc.) a second level of access and/or permission may be granted (e.g., a limited access that does not allow modification to operating parameters or setpoints, a limited access that only allows viewing a subset of data or device information, etc.).

According to an exemplary embodiment, the control panel 502 is configured to communicate with components of the services system 500 (e.g., via the network 508, via other communication protocols, etc.). For example, the control panel 502 may communicate with the user device 504, the computing system 506, and/or one or more systems and/or subsystems described herein (e.g., the fire safety system 430, the security subsystem 438, the HVAC subsystem 440, etc.). The control panel 502 may be configured to receive data and/or information from components of the services system 500 (e.g., the user device 504, the computing system 506, the fire safety system 430, the security subsystem 438, the HVAC subsystem 440, etc., process and/or encode a quick response (QR) code using the information and/or data, and/or display the QR code, for example to be scanned by a device to cause one or more applications and/or interfaces to be provided.

As shown, the control panel 502 may be configured to communicate with the user device 504. The user device 504 may include one or more human-machine interfaces or client interfaces (e.g., a graphical user interface, reporting interface, text-based computer interface, client-facing we service, web services that provide pages to a web client, etc.), shown as display 520 and a camera 522. The user device 504 may be a computer workstation, a client terminal, a remote or local interface, and/or any other type of user interface device. The user device 504 may also be a stationary terminal, or a mobile device. For example, the user device 504 may be a desktop computer, a computer service with a user interface, a laptop computer, a tablet, a smartphone, a PDA, and/or any other type of mobile or non-mobile device. According to an exemplary embodiment, the camera 522 is configured to capture an image and/or video of the QR code 512, for example to cause the user device 504 to provide (e.g., activate, populate, launch, etc.) one or more applications and/or interfaces, as described herein.

In an exemplary embodiment, the user device 504 includes a device manager 524 and one or more device or local applications, shown as local applications 526. According to an exemplary embodiment, the device manager 524 is configured to process data and/or information, for example data and/or information included in the QR code 512 (e.g., scanned via the camera 522, etc.), and cause the user device 504 to provide (e.g., activate, launch, generate, etc.) one or more applications and/or interfaces.

For example, in response to scanning the QR code 512 via the camera 522, the device manager 524 may cause the user device 504 to launch and/or activate an application (e.g., one of the local applications 526) and/or an associated interface based on the QR code 512. As described herein, the one or more local applications 526 may relate to one or more products, services, and/or other information associated with one or more components of the services system 500. For example, the local applications 526 may be associated with a commissioning application, a service application, a maintenance application, an asset tracking application, an invoice application, and/or any other suitable application and/or interface described herein.

In some embodiments, in response to scanning the QR code 512 (e.g., via the camera 522), the device manager 524 may cause the user device 504 to launch another application and/or interface (e.g., a remote or cloud based-application). For example, the device manager 524 may cause the user device 504 to launch a website or webpage, for example associated with a remote or cloud-based asset tracking application (e.g., hosted or executed within the computing system 506, etc.). In other embodiments, in response to scanning the QR code 512, the device manager 524 may cause the user device 504 to provide (e.g., launch, activate, provide, etc.) one or more other interfaces and/or applications, for example associated with another building management system, a maintenance system, a commissioning system, an energy management system, an equipment dashboard system, and/or any other suitable system and/or service described herein.

As will be described herein, in some embodiments the QR code 512 causes the user device 504 to provide (e.g., launch, generate, activate, etc.) one or more applications or interfaces, which provide information and/or recommendations regarding one or more actions. For example, the user device 504 may provide one or more applications or interfaces which provide information relating to one or more recommended maintenance and/or mitigative actions, including, for example, a recommended component or part to repair or replace, a maintenance action to implement, a preventative or mitigative action to implement, and/or another suitable action to implement (or cease implementing).

As shown, the control panel 502 may also be configured to communicate with the computing system 506. In some embodiments, the computing system 506 is implemented on one or more processing circuits (e.g., as instructions stored on one or more memory devices and executed on one or more processors). The computing system 506 may also be a computing system or platform, for example which provides digital connections between different computing devices and/or systems. For example, the computing system 506 may provide digital connections between one or more computing applications or cloud-based applications, shown as cloud applications 536.

The cloud applications 536 may be associated with a building management system, a maintenance system, a commissioning system, an energy management system, an equipment dashboard system, and/or any other suitable system and/or service described herein. Similar to the local applications 526, the cloud applications 536 may be used to communicate information (e.g., associated with the associated devices and/or systems, etc.) to the control panel 502, and/or may be provided (e.g., activated, launched, etc.) using one or more devices and/or systems (e.g., the user device 504, the computing system 506, etc.), for example in response to the QR code 512 being scanned.

As shown, the computing system 506 includes one or more artificial intelligence (AI) agents and/or one or more mapping or data schemes, shown as AI engine 532. Further, the computing system 506 is shown to include a database 534. According to an exemplary embodiment, the database 534 may be configured to receive (e.g., via the network 508) and/or store data and/or information associated with the control panel 502. For example, the database 534 may be configured to store information associated with interactions with the control panel 502 (e.g., frequency, time, a device associated with an interaction, an access or permission level associated with the interaction, a device or user identifier associated with an interaction, etc.). Further, the database 534 may be configured to receive (e.g., via the network 508) and/or store data and/or information associated with one or more components of the services system 500. For example, the database 534 may be configured to store information associated with actions implemented and/or associated with a building system and/or subsystem (e.g., the fire safety system 430, the security subsystem 438, the HVAC subsystem 440, etc.). In this regard, the database 534 may be configured to receive and/or store data and/or information associated with an interaction with the control panel 502 and one or more subsequent actions and/or recommendations (e.g., a maintenance action, a repair action, etc.), for example to provide a history (e.g., log, database, etc.) of recommendations and/or actions implemented associated with the services system 500.

According to an exemplary embodiment, the AI engine 532 is configured to receive information and/or data associated with the control panel 502 and/or components of the services system 500, for example to determine one or more correlations between a generated QR code and one or more actions. For example, the AI engine 532 may include one or more machine learning models, which may be trained to draw correlations between a QR code that is generated (e.g., causing an application to be launched, etc.) and an action that is to be implemented (e.g., within a predetermined time period, with a predetermined frequency, etc.). In some embodiments, the AI engine 532 may be trained using data stored in the database 534, information received via the user device 504, information associated with the control panel 502 (e.g., information and/or data associated with interactions with the control panel 502, etc.), and/or any other suitable information described herein.

As shown, the control panel 502 may also be configured to communicate with one or more systems and/or subsystems. For example, the control panel 502 may be configured to communicate with the fire safety system 430, the security subsystem 438, the HVAC subsystem 440, and/or any other suitable system, subsystem, and/or component thereof described herein. According to an exemplary embodiment, the control panel 502 is configured to receive data and/or information associated with the fire safety system 430, the security subsystem 438, and/or the HVAC subsystem 440 (e.g., operating conditions, operating parameters, setpoints, schedules, etc.), process the information, and/or provide (e.g., encode, etc.) the QR code 512, as described herein. In some embodiments, the control panel 502 is configured to receive information and/or data associated with the systems and/or subsystems in real-time, or near real-time. In this regard, in some embodiments, the control panel 502 may be configured to receive real-time (or near real-time) data, for example indicating changes in conditions of the fire safety system 430, the security subsystem 438, and/or the HVAC subsystem 440. As described herein, the control panel 502 may be configured to dynamically update the QR code 512 (e.g., using the changes in conditions of the systems and/or subsystems, etc.), for example to generate and/or provide a QR code that provides (e.g., launches, activates, etc.) one or more applications and/or interfaces associated with the updated conditions.

### Services Control Panel

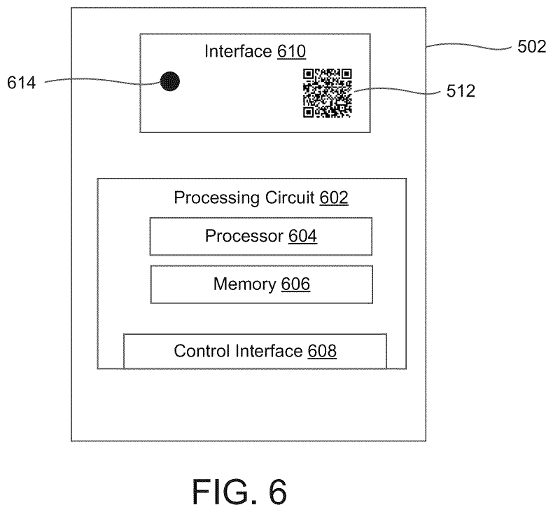

Referring now to FIG. 6, a control panel is shown, according to an exemplary embodiment. In an exemplary embodiment, the control panel of FIG. 6 is the control panel 502 of FIG. 5. As described herein, the control panel 502 may be implemented with one or more components of a building management system. For example, the control panel 502 may be implemented with the BMS 11, a component of the BMS subsystems 20-26, and/or a BMS device, as described herein. According to an exemplary embodiment, the control panel 502 is configured to execute one or more system control functions relating to a building (e.g., the building 10). For example, the control panel 502 may be configured to initiate one or more automated actions or control decisions (e.g., changing or setting point states, system starts, stops, or resets, alarm acknowledgement or initiation, etc.) relating to one or more components of a building (e.g., a component or device of the building (e.g., a device or component of the electrical subsystem 434, the information communication technology (ICT) subsystem 436, the security subsystem 438, the HVAC subsystem 440, the lighting subsystem 442, the lift/escalators subsystem 432, and/or the fire safety subsystem 430, etc.). Further, the control panel 502 may also be configured to display information relating to one or more components of a building (e.g., the building 10), for example information relating to a component or device of the BMS subsystems 20-26.

As shown in FIG. 6, the control panel 502 includes a processing circuit 602 including a processor 604 and memory 606. Processing circuit 602 can be communicably connected to a control interface 608, such that processing circuit 602 and the various components thereof can send and receive data (e.g., via control interface 608). Processor 604 can be implemented as a general purpose processor, an application specific integrated circuit (ASIC), one or more field programmable gate arrays (FPGAs), a group of processing components, or other suitable electronic processing components. The processing circuit 602 can include a variety of input and output ports, wireless transceivers, etc. suitable for establishing wired and/or wireless communications with various building devices (e.g., controllers, equipment, gateways, servers, etc.), for example such that the control panel 502 can serve as a hub for configuring, coordinating, monitoring, etc. various elements of a BMS.

Memory 606 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 606 can be or include volatile memory or non-volatile memory. Memory 606 can include database components, object code components, script components, or any other type of information structure for supporting the various activities and information structures described in the present application. According to some embodiments, memory 606 is communicably connected to processor 604 via processing circuit 602 and includes computer code for executing (e.g., by processing circuit 602 and/or processor 604) one or more processes described herein.

As shown in FIG. 6, the control panel 502 further includes a display or interface, shown as display 610. According to an exemplary embodiment, the display 610 includes a machine readable code, shown as quick response code or the QR code 512. As described herein, the QR code 512 may be configured to contain information, for example encoded information relating to the control panel 502. In an exemplary embodiment, the QR code 512 is scannable (e.g., via a camera, a user device, a mobile device, the camera 522 of the user device 504, etc.), and is configured to populate one or more applications and/or interfaces that provide (e.g., display, etc.) information relating to the control panel 502 and/or connected systems or devices (e.g., a component of device of the BMS subsystems 20-26, etc.). According to an exemplary embodiment, the processing circuit 602 (e.g., the processor 604, memory 606, etc.) is configured to collect information relating to the control panel 502 and/or connected devices, process the information, and/or generate the QR code 512 for display on the display 610. In some embodiments, the processing circuit 602 (e.g., the processor 604, memory 606) is implemented with one or more machine learning algorithms and/or generative artificial intelligence, such that the QR code 512 is generated based on historical data and/or includes predictive indicators (e.g., interfaces, actions, instructions, recommendations, etc.) associated with the control panel 502 and/or connected devices.

In an exemplary embodiment, the QR code 512 is dynamically updated, for example to provide updated or real-time information relating to the control panel 502 and/or connected devices. For example, the control panel 502 may be configured to receive information and/or data from the systems and/or subsystems described herein (e.g., one or more conditions associated with the fire safety system 430, the security subsystem 438, and/or the HVAC subsystem 440, etc.), and dynamically update the QR code 512, for example to provide a QR code 512 that causes one or more applications and/or interfaces (e.g., an updated application, a different application of the one or more local applications 526, etc.) to be launched, activated, and/or otherwise provided.

In some embodiments, the QR code 512 is updated in real-time, or at one or more predetermined intervals (e.g., hourly, once a day, once a week, etc.). The QR code 512 may be updated in response to one or more events associated with or affecting the control panel 502 and/or a connected device (e.g., an update or device upgrade, a service or maintenance event, an alarm or security event, detection of a user or operator within a field surrounding the control panel 502, detection of a user or operator interacting with the control panel 502, etc.). In other embodiments, the QR code 512 is static, for example the QR code 512 is provided with the control panel 502 upon manufacturing. It should be understood that while the machine readable code is shown and described herein as the QR code 512, in other embodiments the QR code 512 is another machine readable code (e.g., a 2-dimensional code, an alphanumeric code, a bar code, etc.) or another suitable communications protocol (e.g., near field communication (NFC) tag, image recognition, Bluetooth beacon, etc.).

As shown in FIG. 6, the control panel 502 also includes a camera 614, according to an exemplary embodiment. In an exemplary embodiment, the camera 614 is configured to capture audio/visual information surrounding the control panel 502 (e.g., audio, images, video, etc.). The camera 614 may be configured to communicate the captured audio/visual information to the processing circuit 602 (e.g., the processor 604, memory 606), for example to be included in the generated QR code 512. In some embodiments, the camera 614 is configured to activate in response to one or more events associated with or affecting the control panel 502 and/or a connected device. For example, the camera 614 may activate in response to detecting the presence of an individual (e.g., a service technician, a visitor, etc.) within a predetermined field surrounding the control panel 502. In some embodiments, the camera 614 is configured to activate in response to an engagement with the QR code 512 (e.g., in response to a user or operator scanning the QR code 512, etc.). In other embodiments, the camera 614 is configured to activate at one or more predetermined intervals and/or in response to one or more inputs or commands (e.g., hourly, daily, in response to a user input or command, etc.).

In some embodiments, the camera 614 is an infrared camera; however, in other embodiments the camera 614 is and/or includes another suitable device configured to capture audio and/or visual information associated with the control panel 502 (e.g., a microphone, a sensor, etc.). The camera 614 may be physically mounted on the control panel 502 so as to capture video of a user facing the control panel 502 (as shown in FIG. 6), or may be external to the control panel 502 and mounted in a position that provides the control panel 502 with a perspective to view the user's interaction with the control panel 502 (e.g., coupled via a cable to the control panel 502 and mounted on a ceiling, opposing wall, etc. of a space containing the control panel 502).

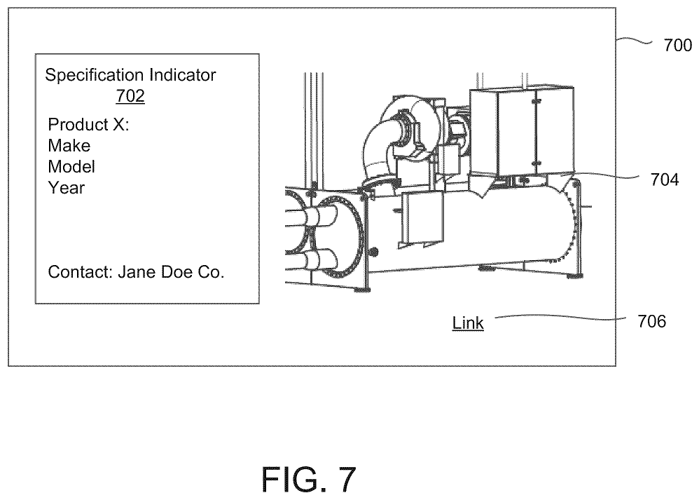

Referring generally to FIGS. 7-10, a plurality of exemplary applications, application interfaces, and/or interfaces are shown, according to exemplary embodiments. As discussed above, in an exemplary embodiment the QR code 512 is scannable, for example via a camera on a user device (e.g., the user device 504). In response to scanning the QR code 512, the QR code 512 may be configured to provide (e.g., launch, populate, etc.) one or more applications and/or interfaces on the device (e.g., tablet, phone, electronic device, etc.), for example the applications and/or interfaces shown in FIGS. 7-10.

As discussed above, in an exemplary embodiment the QR code 512 is generated using one or more machine learning algorithms and/or generative artificial intelligence, such that the QR code 512 is configured to launch an application (e.g., an application or interface of FIGS. 7-10) tailored to a user or operator (e.g., based on a date or time, based on an event or service associated with the control panel 502 and/or a connected device, based on a command provided by a user or operator, etc.). In some embodiments, the QR code 512 is configured to generate and/or provide an interface tailored to a user or operator. Advantageously, the processing circuit 602 is configured to receive information from one or more disparate systems (e.g., a service or maintenance software, a purchasing or invoice system, a customer or sales database, etc.) and generate the QR code 512 containing encoded information relating to the systems, which when scanned populates (e.g., launches, activates, generates, etc.) an application and/or an interface tailored to the user so as to improve efficiencies (e.g., in maintenance or servicing processes, purchasing processes, etc.) and/or reduce resources (e.g., human capital, computational resources) in servicing one or more components of the building 10.

Referring now to FIG. 7, an exemplary application and/or user interface, shown as display 700 is shown, according to some embodiments. According to an exemplary embodiment, the display 700 is associated with a product specification application. In some embodiments, the display 700 is or includes a product specification interface. As shown in FIG. 7, the display 700 includes a specification indicator or widget, shown as specification indicator 702. The specification indicator 702 may display information relating to the control panel 502 and/or connected systems or devices (e.g., make, model, year, etc.). In some embodiments, the specification indicator 702 includes contact information (e.g., name, address, phone number, etc.) of the manufacturer or provider. In an exemplary embodiment, the display 700 includes drawings or schematics of the control panel 502 and/or one or more connected devices, shown as product indicator 704. In some embodiments, the product indicator 704 is a digital representation of the control panel 502 and/or one or more connected devices (e.g., a digital twin, etc.). The display 700 may also include a webpage or product link, shown as specification link 706, which when engaged may populate a secondary interface or page, for example containing additional product specification details. In some embodiments, the specification link 706 may be engaged to populate a secondary interface or page including a digital representation of the product (e.g., a digital twin, etc.).

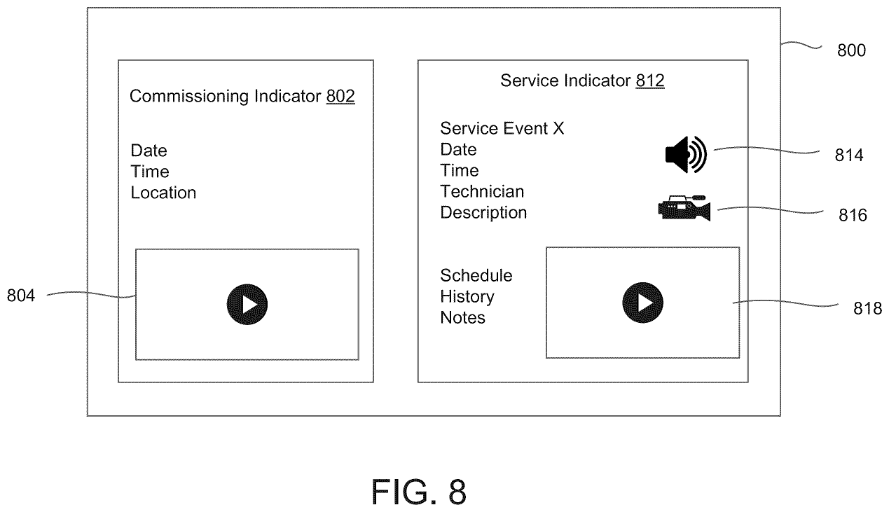

Referring now to FIG. 8, an exemplary application and/or user interface, shown as display 800 is shown, according to some embodiments. According to an exemplary embodiment, the display 800 is associated with a commissioning and service application. In some embodiments, the display 800 is or includes a commissioning and service interface. As shown in FIG. 8, the display 800 includes a commissioning indicator or widget, shown as commissioning indicator 802. The commissioning indicator 802 may display information relating to the commissioning of the control panel 502 and/or connected systems or devices (e.g., day, time, location, etc.). In some embodiments, the commissioning indicator 802 includes an audio or visual indicator, shown as video widget 804. The video widget 804 may be selectable, for example to present audio or video relating to commissioning or service events. In an exemplary embodiment, the video widget 804 is selectable to display a video replay of the initial commissioning of the control panel 502 and/or connected devices. Advantageously, the video widget 804 may display information (e.g., a video replay, etc.) to a user or observer, for example to provide context or reference information relating to initial device commissioning to allow a user (e.g., technician, etc.) to more efficiently and/or effectively assess potential issues or problems relating to the control panel 502 and/or connected devices.

In some scenarios, the video widget 804 plays video recorded by the camera 614, for example video records which were automatically collected by the control panel 502 and the camera 614 during commissioning or prior service of the control panel 502. In other scenarios, the video widget 804 plays video recorded by a separate camera, for example a camera associated with a service technician (e.g., a smartphone of the service technician). The service technician may be provided with an application running on a camera device which can cause the camera device (e.g., smartphone) to record video as the service technician provides service to the control panel 502 and automatically detect the QR code 512 in the recorded video and, based on the QR code 512, automatically store the recorded video in a manner associated with the particular control panel 502 so as to be accessible to the video widget 804. Recorded video, even if collected by an external camera separate from the control panel 502, can thereby be automatically and reliably associated with the control panel 502 and replayed via the video widget 804 without requiring a service technician to manually save the recorded video to a proper file.

The display 800 is also shown to include a service indicator or widget, shown as service indicator 812. The service indicator 812 may display information relating to one or more service events performed on the control panel 502 and/or connected systems or devices. For example, the service indicator 812 may display information relating to a service event X (e.g., date, time, technician, a description of the service performed, etc.). In some embodiments, the service indicator 812 includes contact information of the service provider and/or servicing technician (e.g., name, address, phone number, etc.). In other embodiments, the service indicator 812 includes a selectable service link, which when engaged may be configured to populate a secondary interface or page containing additional information relating to the service provider and/or the technician.

The service indicator 812 is shown to also include a selectable service schedule widget, which may be selected to display one or more service schedules associated with the control panel 502 and/or connected systems or devices. For example, in response to a selection of the service schedule widget, the service indicator 812 may display a schedule (e.g., calendar, etc.) displaying historical service events and/or upcoming scheduled or recommended service events. The service indicator 812 is also shown to include a selectable service history widget, which may be selected to display a timeline of historical service events performed on the control panel 502 and/or connected systems or devices. For example, in response to a selection of the service history widget, the service indicator 812 may display a timeline of historical service events and/or information associated with each event (e.g., recommended service, service that was performed, etc.). In some embodiments, the service indicator 812 includes a selectable service notes widget, which may be selected to display notes or comments (e.g., of a technician, user, manufacturer, service provider, etc.) associated with the one or more service events.

In an exemplary embodiment, the service indicator 812 also includes an audio indicator 814 and a visual indicator 816. The audio indicator 814 and the visual indicator 816 may be selectable (e.g., by an operator, user, technician, etc.). For example, in response to the audio indicator 814 being selected, the control panel 502 (e.g., a microphone, etc.) may articulate information relating to one or more service events to a user or operator (e.g., a technician wearing protective gear, etc.). In some embodiments, in response to the audio indicator 814 being selected, the control panel 502 (e.g., the camera 614, a microphone, etc.) may record and/or store a dictation or audible account (e.g., from a technician or user), for example to store an audible account of a service event or notes associated with a service event. Similarly, in response to the visual indicator 816 being selected, the display 800 (e.g., a service video widget 818) may display information relating to one or more service events to a user or operator. In some embodiments, in response to the visual indicator 816 being selected, the control panel 502 (e.g., the camera 614, etc.) may record and/or store a video or visual account (e.g., of a technician or user), for example to store a video of a service event being performed. Advantageously, the display 800 (e.g., audio indicator 814, visual indicator 816) may provide more precise tracking and/or record keeping (e.g., verification, etc.) of service events performed on the control panel 502 and/or one or more connected devices. In some embodiments, the indicators 814, 816 are configured to be automatically selected (e.g., to provide audio/visual display, to record an audio/visual record, etc.), for example in response to the QR code 512 being scanned. In some embodiments, the present disclosure contemplates automatically generating a record of the service event, data for a warranty claim, bill, using generative artificial intelligence based on such audio and/or video recordings to reduce or eliminate paperwork to be completed by technicians and improving accuracy and completeness of such outputs (e.g., using teachings according to U.S. Provisional Patent No. 63/470,074 filed May 31, 2023, the entire disclosure of which is incorporated by reference herein).

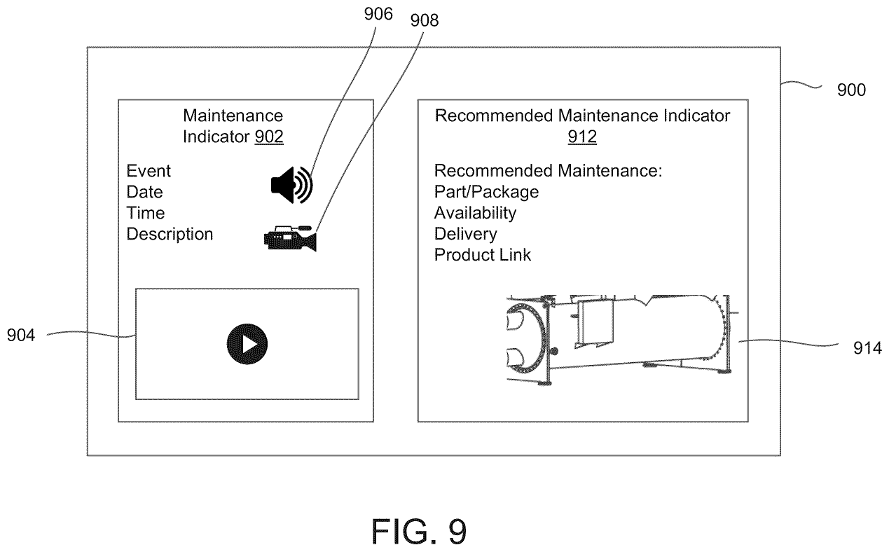

Referring now to FIG. 9, an exemplary application and/or user interface, shown as display 900 is shown, according to some embodiments. According to an exemplary embodiment, the display 900 is associated with a maintenance application. In some embodiments, the display 900 is or includes a maintenance interface. As shown in FIG. 9, the display 900 includes a maintenance indicator or widget, shown as maintenance indicator 902. The maintenance indicator 902 may display information relating to one or more maintenance events performed on the control panel 502 and/or connected systems or devices (e.g., day, time, location, etc.). In some embodiments, the maintenance indicator 902 includes an audio or visual indicator, shown as visual widget 904. The visual widget 904 may be selectable, for example to present audio or video relating to a maintenance event. Advantageously, the visual widget 904 may display information (e.g., video replay, etc.) to a user or observer, for example to provide more precise tracking and/or record keeping (e.g., verification, etc.) of maintenance events performed on the control panel 502 and/or one or more connected devices.

In some embodiments, the maintenance indicator 902 includes an audio indicator 906 and a video indicator 908. Similar to the indicators 814, 816 discussed herein, the audio indicator 906 and the video indicator 908 may be selectable (e.g., by an operator, user, technician, etc.). For example, in response to the audio indicator 906 being selected, the control panel 502 (e.g., a microphone, etc.) may articulate information relating to one or more service events to a user or operator (e.g., instructions for how to perform a maintenance event, an audio record of a maintenance event performed, etc.). In some embodiments, in response to the audio indicator 906 being selected, the control panel 502 may record and/or store an audible account of a maintenance event or notes associated with the maintenance event. Similarly, in response to the video indicator 908 being selected, the display 900 (e.g., the visual widget 904, etc.) may display information relating to one or more maintenance events to a user or operator. In other embodiments, in response to the video indicator 908 being selected, the control panel 502 (e.g., the camera 614, etc.) may record and/or store a video or visual account of the maintenance being performed. Advantageously, the display 900 (e.g., audio indicator 906, video indicator 908) may provide more precise tracking and/or record keeping (e.g., verification, etc.) of maintenance events performed on the control panel 502 and/or one or more connected devices. In some embodiments, the indicators 906, 908 are configured to be automatically selected (e.g., to provide audio/visual display, to record an audio/visual record, etc.), for example in response to the QR code 512 being scanned.

The display 900 is also shown to include a recommended maintenance indicator 912, according to some embodiments. The indicator 912 may display information relating to one or more recommended maintenance events. For example, the indicator 912 may display a description of a recommended maintenance event and/or a recommended part or part package to facilitate completing the recommended maintenance event. In an exemplary embodiment, the indicator 912 includes information relating to the recommended part or package availability (e.g., part numbers, number of parts available, a location of the parts, a manufacturer of the parts, etc.). In some embodiments, the indicator 912 includes an indication of a status of the part or part package (e.g., discontinued, currently available, on sale, limited supply, etc.). In other embodiments, the indicator 912 includes a list of associated or similar parts relative to the recommended part, for example to provide a list of similar parts if the recommended part is discontinued or unavailable. In some embodiments, the indicator 912 includes a status indicator of a current part or part package to receive a recommended maintenance event, for example a projected or expected end life of the part or part package.

The indicator 912 may include information relating to a price or quote associated with the recommended part or part package (e.g., a lowest price quote, a price quote comparison, a list of available parts and associated prices, etc.). The indicator 912 may also include information relating to the expected or projected delivery date (e.g., lead time, etc.) of the recommended part or part package. As shown in FIG. 9, the indicator 912 may also include a selectable product link, which when engaged may be configured to populate a secondary interface or page containing additional information relating to the part or package of parts (e.g., price, availability, manufacturer, reviews, etc.). In an exemplary embodiment, the product link is selectable, for example to automate (e.g., initiate) ordering or purchasing of the recommended part or package of parts. Advantageously, the indicator 912 allows a user to effectively evaluate available parts for a recommended maintenance event, and efficiently purchase the recommended parts (or similar parts) to perform the recommended maintenance event. In some embodiments, the indicator 912 also includes a digital representation of the recommended part or part package, shown as part widget 914. The part widget 914 may be a digital representation of he recommended part or part package (e.g., a digital twin, digital representation, etc.), which when engaged may display additional information relating to the part or part package.

The display 900 can thereby provide data and guidance for the control panel 502 across a building life cycle, from installation, commissioning, repairs, maintenance, upgrades, and eventual decommissioning. In some embodiments, such building lifecycle data is aggregated, presented, generated, etc. using one or more artificial intelligence techniques, for example as described in U.S. Provisional Patent Application No. 63/530,311 filed Aug. 2, 2023, the entire disclosure of which is incorporated by reference herein.

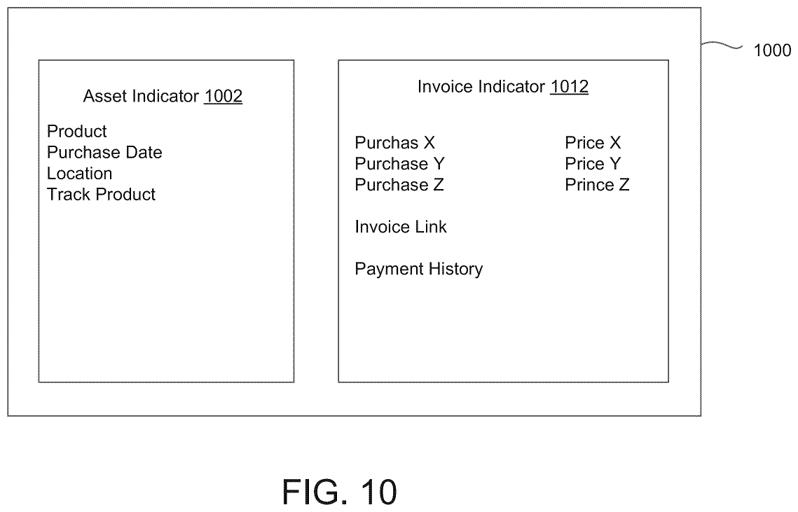

Referring now to FIG. 10, an exemplary application and/or user interface, shown as display 1000 is shown, according to some embodiments. According to an exemplary embodiment, the display 1000 is associated with an asset tracking and invoice application. In some embodiments, the display 1000 is or includes an asset tracking and invoice interface. As shown in FIG. 10, the display 1000 includes an asset tracking indicator or widget, shown as asset indicator 1002. The asset indicator 1002 may display information relating to one or more assets and/or purchases. For example, the asset indicator 1002 may include a product or product package description, a purchase date, a price, a location or status of the purchased product or package, and/or a link to monitor or track the status (e.g., location, etc.) of the purchased product.

The display 1000 is also shown to include an invoice indicator or widget, shown as invoice indicator 1012. The invoice indicator 1012 may display information relating to one or more invoices (e.g., product or service description, date, time, price, purchaser information, etc.). In some embodiments, the invoice indicator 1012 includes a selectable link, shown as invoice link, which is selectable to display additional information relating to one or more invoices (e.g., product or service description, a warranty associated with a product, etc.). The invoice link may also be selectable to display an audio or visual indicator, for example an audio not associated with a completed service and/or a video replaying or showing the service completed. In other embodiments, the invoice indicator 1012 includes a selectable payment history link, which is selectable to display a payment history page or interface.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A control panel, comprising:
a display configured to display a quick response (QR) code; and
a processing circuit having a processor and a memory having computer-executable instructions embodied therein that, when executed by the processor cause the processing circuit to perform operations comprising:
receiving, from a plurality of systems associated with a building, building data; and
encoding the QR code based on the building data such that the QR code changes responsive to changes in the building data, wherein the changes in the QR cause the QR code to provide different interfaces or applications when scanned by a user device.

2. The control panel of claim 1, wherein the operations further comprise:
receiving, from at least one of the plurality of systems associated with the building, updated building data that indicates a change from a first scenario associated with the control panel to a second scenario associated with the control panel; and
dynamically updating the QR code such that the QR code changes from directing to content associated with the first scenario to content associated with the second scenario.

3. The control panel of claim 2, wherein, prior to dynamically updating the QR code, the QR code provides a commissioning interface configured to display a video showing a commissioning procedure of a piece of building equipment communicably coupled to the control panel; and
wherein, after dynamically updating the QR code, the QR code provides a recommendation including a recommended maintenance procedure on the piece of building equipment communicably coupled to the control panel.

4. The control panel of claim 3, wherein the recommendation includes at least one of (i) a recommended package of parts associated with the recommended maintenance procedure, (ii) a recommended part associated with the recommended maintenance procedure and a projected delivery date for the recommended part, or (iii) a virtual model of a recommended part associated with the recommended maintenance procedure that displays the recommended part assembled with the piece of building equipment.

5. The control panel of claim 3, wherein the recommendation includes a link to a recommended part associated with the recommended maintenance procedure, wherein the link is selectable to automatically purchase the recommended part.

6. The control panel of claim 1, wherein the QR code provides service information including at least one of (i) a service event performed on a piece of building equipment communicably coupled to the control panel or (ii) a video showing a service procedure of the service event performed on the piece of building equipment.

7. The control panel of claim 1, wherein the QR code provides asset tracking information including a timeline of a plurality of purchases of products and services associated with the building.

8. The control panel of claim 1, wherein the QR code provides invoice information including at least one of (i) a timeline of a plurality of invoices for products and services associated with the building or (ii) a link to a video showing a service procedure associated with one of the plurality of invoices for a service associated with the building.

9. The control panel of claim 1, wherein the control panel further includes a camera, and wherein in response to the QR code being scanned the camera is activated to record a video of a field surrounding the control panel.

10. The control panel of claim 1, wherein the operations further comprise:
running the building data with a machine learning algorithm to generate a modified building data set, and wherein encoding the QR code with the building data includes encoding the QR code with the modified building data set.

11. The control panel of claim 1, wherein the operations further comprise:
receiving, from at least one of the plurality of systems associated with the building, event data associated with an event affecting a piece of building equipment communicably coupled to the control panel; and
wherein encoding the QR code includes encoding the QR code based on the event data, and wherein the QR code provides building data associated with the event.

12. The control panel of claim 1, wherein the QR code provides a product specification information including at least one of (i) information relating to a piece of building equipment communicably coupled to the control panel or (ii) a warranty and projected end of life associated with the piece of building equipment.

13. A building device, comprising:
a display configured to display a quick response (QR) code; and
a processing circuit having a processor and a memory having computer-executable instructions embodied therein that, when executed by the processor cause the processing circuit to perform operations comprising:
receiving, from equipment or devices associated with a building, building data; and
encoding the QR code based on the building data such that the QR code changes responsive to changes in the building data, wherein in response to the QR code being scanned an interface is provided that includes a service, maintenance, and/or upgrade recommendation relating to the building.

14. The building device of claim 13, wherein the operations further comprise:
receiving, from at least one of the equipment or devices associated with the building, updated building data that indicates a change from a first scenario associated with a control panel to a second scenario associated with the control panel; and
dynamically updating the QR code such that the QR code changes from directing to content associated with the first scenario to content associated with the second scenario.

15. The building device of claim 13, wherein, prior to dynamically updating the QR code, the QR code provides a commissioning interface configured to display a video showing a commissioning procedure of a piece of building equipment communicably coupled to a control panel; and
wherein, after dynamically updating the QR code, the QR code provides is a recommendation including a recommended maintenance procedure on the piece of building equipment communicably coupled to the control panel.

16. The building device of claim 13, wherein the building device further includes a camera, and wherein in response to the QR code being scanned the camera is activated to record a video of a field surrounding the building device.

17. The building device of claim 13, wherein the operations further comprise:
running the building data with a machine learning algorithm to generate a modified building data set, and wherein encoding the QR code with the building data includes encoding the QR code with the modified building data set.

18. A non-transitory computer-readable storage media having computer-executable instructions stored thereon that, when executed by one or more processors, cause the one or more processors to perform operations comprising:
receiving, from a plurality of systems associated with a building, building data; and
encoding a scannable code based on the building data such that the scannable code changes responsive to changes in the building data, wherein the changes in the scannable code cause the scannable code to provide different interfaces or applications when scanned by a user device.

19. The non-transitory computer-readable storage media of claim 18, wherein the operations further comprise:
receiving, from at least one of the plurality of systems associated with the building, updated building data that indicates a change from a first scenario associated with a control panel to a second scenario associated with the control panel; and
dynamically updating the QR code such that the QR code changes from directing to content associated with the first scenario to content associated with the second scenario.

20. The non-transitory computer-readable storage media of claim 18, prior to dynamically updating the QR code, the QR code provides is a commissioning interface configured to display a video showing a commissioning procedure of a piece of building equipment communicably; and
wherein, after dynamically updating the QR code, the QR code provides a recommendation including a recommended maintenance procedure on the piece of building equipment.
